(19) United States
(12) Patent Application Publication
(10) Pub. No.: US 2008/0024958 A1
(43) Pub. Date: Jan. 31, 2008

(54) INPUT INTERFACE INCLUDING PUSH-SENSITIVE MECHANICAL SWITCH IN COMBINATION WITH CAPACITIVE TOUCH SENSOR

(76) Inventors: Dennis M. Mudd, Poway, CA (US); Tibor Csicsatka, Escondido, CA (US); David Parise, San Marcos, CA (US); David Benavidez, Santa Clara, CA (US); Afshin Mehin, San Jose, CA (US); Dan Harden, Palo Alto, CA (US)

Correspondence Address: COOLEY GODWARD KRONISH LLP;ATTN: Patent Group, Suite 1100, 777 - 6th Street, NW, Washington, DC, 20001, US

(21) Appl. No.: 11/774,481

(22) Filed: Jul. 6, 2007

Related U.S. Application Data
(60) Provisional application No. 60/806,716, filed on Jul. 6, 2006.
(60) Provisional application No. 60/886,283, filed on Jan. 23, 2007.

(51) Int. Cl. H02B 13/00; G05B 1/01

(52) U.S. Cl. 361/615; 700/297

(57) ABSTRACT

An input interface for an electronic device is disclosed. The input interface includes a touch-sensitive switch supported by a board member. The input interface further includes a push-sensitive switch supported by a circuit board. The board member and circuit board will typically be generally planar and included within substantially parallel layers of the input interface. The touch-sensitive switch and push-sensitive switch form a switch pair that may be associated with a display control function invoked upon actuation of both of the switches.

### CROSS-REFERENCE TO RELATED APPLICATIONS

This application claims priority under 35 U.S.C. §119(e) to co-pending U.S. Provisional Application Ser. No. 60/806,716, entitled INPUT INTERFACE INCLUDING PUSH-SENSITIVE MECHANICAL SWITCH IN COMBINATION WITH CAPACITIVE TOUCH SENSOR, and to co-pending U.S. Provisional Application Ser. No. 60/886,283, entitled DEVICES AND METHODS FOR DISTRIBUTING DIGITAL CONTENT, both of which are incorporated by reference herein for all purposes.

### BACKGROUND OF THE INVENTION

Portable electronic devices have become increasingly popular in recent years, since such devices may be easily carried in, for example, a pocket, handbag, or purse. However, one consequence of this ease of portability tends to be false or spurious actuation of the input interface of the portable unit. Such spurious actuation may arise when attempting to retrieve other objects from a pocket or purse containing the portable device, or when the unit is bumped or otherwise impacted while so contained. Spurious activation may also occur when a user is attempting to actuate a particular input element (e.g., a button or key) while the portable device is out of view and inadvertently engages a different input element.

Since portable electronic devices may be used in a variety of environments, including dark areas or areas with insufficient ambient light for viewing of its input elements, it is often difficult to control the device without moving to an area with adequate lighting. Although some devices are configured to activate a display backlight or other lighting element upon depression of a key or button, such illumination of the display can consume substantial power and the triggering key press may result in the unintended input of information or commands into the device.

Many conventional portable and other electronic devices are designed to transition into operation in a “hibernate mode” in the absence of detection of user input for a predefined period of time. Typically, operation in hibernate mode involves at least turning off the backlight of the device and possibly also initiating other power-saving functions. However, the requirement that a predefined period of time expire prior to entry into hibernate mode means that existing devices tend to stay illuminated or “backlit” too long after being put away in a pocket or purse, resulting in a waste of precious power. On the other hand, devices can also enter hibernate mode (resulting in turn off of the backlight of the device's display) when the user is holding the device and, for example, reading through a screen but not pushing any input buttons or otherwise interacting with the device's input interface. Unfortunately, both of these circumstances tend to result in user dissatisfaction and even irritation.

### SUMMARY OF THE INVENTION

In summary, one aspect of the present invention relates to an electronic device including a housing having at least one outside edge. The device further includes an input interface disposed along at least a portion of the one outside edge. The input interface includes at least one touch-sensitive switch and at least one push-sensitive switch. In one embodiment the touch-sensitive switch and push-sensitive switch are located in different layers of the input interface and comprise a switch pair positioned proximate a location associated with a particular display control function. A processor receives and processes input signals generated by the touch-sensitive switch and push-sensitive switch in response to user input. In other embodiments the input interface may include additional switch pairs of similar configuration associated with other display control functions.

In another aspect the present invention is directed to an input interface for an electronic device. The input interface includes a first touch-sensitive switch supported by a board member. The input interface further includes a first push-sensitive switch supported by a circuit board. In one embodiment the board member and circuit board are generally planar and included within substantially parallel layers of the input interface.

The present invention also relates to a method of controlling a display interface of an electronic device using an input interface of the device. The method includes generating, upon touching by a user of a surface of the input interface, a first input signal. The method further includes generating, upon application by the user of a pushing force to the surface of the input interface, a second input signal. A first control signal is then provided to the display interface in response to the first input signal and the second input signal. In one embodiment the touching and the pushing forces are applied proximate a first location of the input interface associated with a corresponding first display control function.

### BRIEF DESCRIPTION OF THE DRAWINGS

For a better understanding of the nature of the features of the invention, reference should be made to the following detailed description taken in conjunction with the accompanying drawings, in which:

FIG. 1 shows a portable electronic audio player having a side surface incorporating an embodiment of an input interface of the present invention.

FIG. 2 is a block diagram depicting a principal set of components of an audio player incorporating the inventive input interface.

FIGS. 3A-3C provide various views of an exemplary implementation of the input interface of the audio player of FIG. 2.

FIG. 4 provides a flowchart of an exemplary sequence of actions occurring in connection with activating one of the control elements of the inventive input interface.

FIG. 5 is a flowchart depicting an exemplary sequence of actions occurring in connection with activation of a scroll up control function facilitated by the scroll bar of the inventive input interface.

FIG. 6 is a flowchart depicting an exemplary sequence of actions occurring in connection with activation of a scroll down control function facilitated by the scroll bar of the inventive input interface.

FIG. 7 shows an audio player configured with an input interface having a touch-sensitive scroll bar realized along a front surface of the device independently from a set of combination push-sensitive/touch-sensitive control buttons located on an adjacent side surface of the player.

### DETAILED DESCRIPTION OF EMBODIMENTS OF THE INVENTION

Embodiments of the invention generally relate to an input interface for a portable or other electronic unit comprised of a push-sensitive element in combination with a touch-sensitive element. In an exemplary embodiment the push-sensitive element is comprised of a mechanical switch and the touch-sensitive element comprises a capacitive-resistant control responsive to skin contact. The inventive input interface advantageously limits accidental and other spurious actuation of the input interface and the required range of finger motion.

A method of providing user input to a portable electronic unit in accordance with one embodiment of the invention comprises detecting that skin contact has been made with at least one control portion of the input interface. Such detection does not result in actuation of the control portion of the input interface, but may cause illumination of such portion for the benefit of the user. Once such detection of skin contact has occurred, actuation of such portion may be completed by pushing an underlying mechanical button. Only after input signals indicating that both such skin contact and mechanical push operations have been generated is the selected portion of the input interface activated. An output signal generated in response to these input signals may then be used in connection with navigation of a display of the portable unit. Such navigation may include, for example, scrolling through information presented by the display or selecting from a list of options presented by the display.

Embodiments of the input interface of the present invention reduce spurious actuation of input interface elements or controls by preventing pushing actions in the absence of skin contact, and skin contact in the absence of pushing action, from being interpreted as valid user input. It follows that light placement of fingers or hands on an input controls will not cause a button or other input element to be actuated; instead, the user must still apply normal mechanical button pushing force to the element to effect its actuation. This characteristic of embodiments of the invention allows buttons or other input elements to be placed directly upon the outside edges or other surfaces of a portable device since neither mechanical force, nor light hand or finger touches, will alone will cause the element to be activated.

The above characteristics of the inventive input interface may also enable the timing of entry into, and exit from, hibernate modes to occur in a manner which reduces user annoyance and dissatisfaction. In particular, these characteristics enable hibernate mode to be entered (and turn off of the portable device's backlight to occur) nearly instantly following placement of the portable device into the user's pocket or carrying bag. Similarly, hibernate mode can also be exited nearly instantly (and the backlight turned on) after the user merely touches the device in his or her pocket or carrying bag. As a consequence, the portable device is illuminated by the time the user has moved it into a suitable viewing position.

The combination input interface of the present invention offers a number of other advantages of interest to users. For example, when a user pushes a button with normal button force using their finger, they will experience the “click” and mechanical tactile response expected upon push of a conventional button. Moreover, embodiments of the invention may be configured such that lightly laying a finger over the input interface to, for example, search for a specific button by hand, may cause the button to show a glow state but will not actuate the button. The buttons may have raised, cutout or formed contours enabling a user to feel and ascertain the position of the buttons even when the user is unable to view them.

In one implementation the inventive input interface includes a capacitive-resistant scroll bar. In this embodiment the scroll bar is actuated in response to sliding of the user's finger over “scroll up” or “scroll down” control portions of the scroll bar. These “scroll up” and “scroll down” control portions generate output signals causing a list of information appearing upon the display of the applicable portable unit to be scrolled up or down, respectively. Once the scroll bar is activated, the user may drag their finger farther up the scroll bar to accelerate up the list, or farther down the scroll bar to accelerate down the list. The user can hold down in one spot to maintain constant acceleration through the list. The scroll bar may be designed such that it operates with respect to a fixed zero point located at the midpoint along its length. Alternatively, the scroll bar may be configured such that the user defines the zero point by the spot from which they begin moving their finger. For example, if the finger motion begins in a downward direction from a top end of the scroll bar, dragging of the user's finger farther down the scroll bar will cause increasingly rapid downward scrolling of the displayed list. Once the user lifts his or her finger off of the scroll bar, the displayed list ceases scrolling.

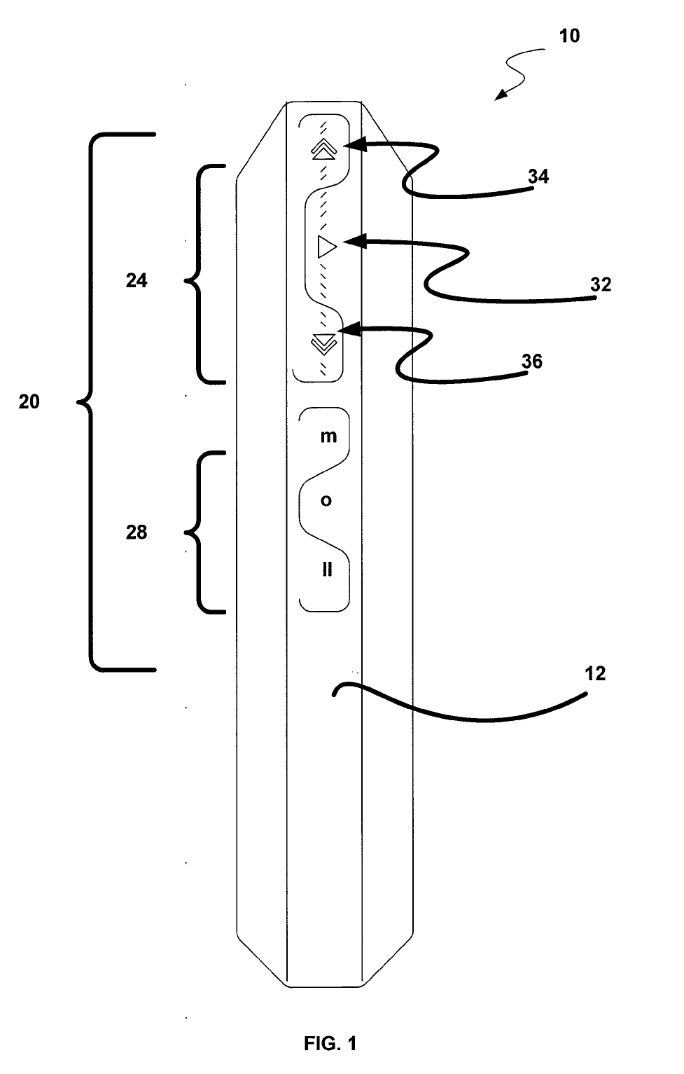

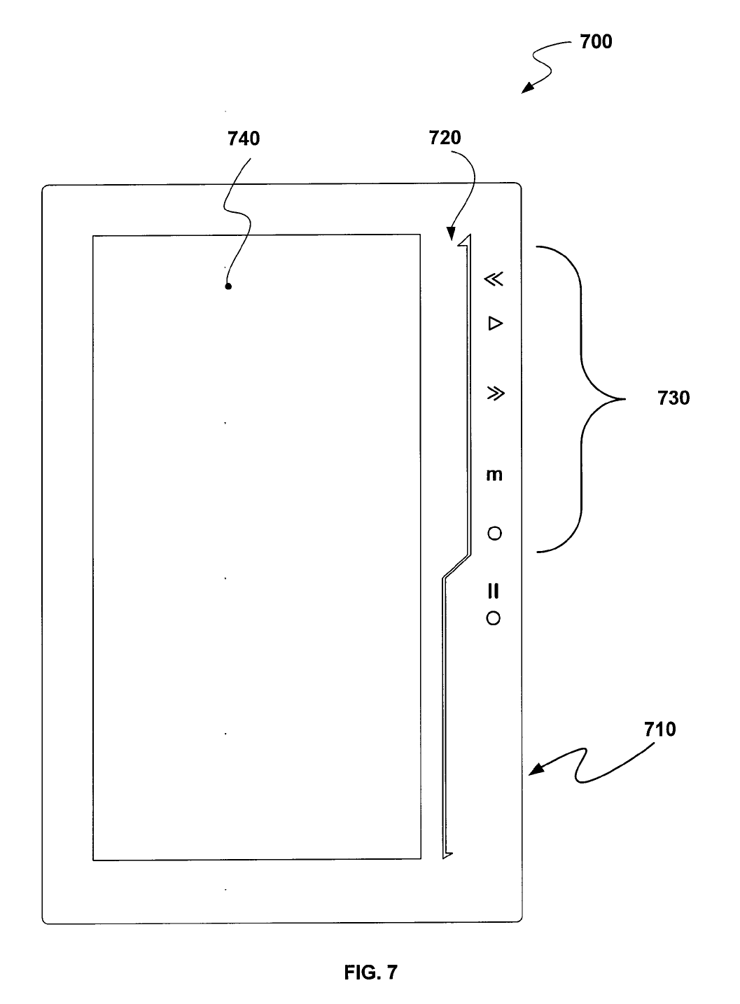

Referring now to FIG. 1, there is shown a portable electronic audio player 10 having a side 12 incorporating an embodiment of the inventive input interface 20. As shown, the input interface 20 is comprised of an integrated structure containing a scroll bar 24 positioned adjacent a plurality of control buttons 28. Various control elements within the scroll bar 24 (e.g., “play/select” switch 32) and each of the control buttons 28 are comprised of at least one touch-sensitive element in combination with a push-sensitive mechanical switch. As is described below with reference to FIG. 7, in other embodiments the scroll bar may comprise a completely independent design element that is implemented separately from any other control buttons. In such embodiments the scroll bar may be located along some or all of the surface of the display frame adjacent to the edge upon which the control buttons are located. In some embodiments the scroll bar may be located along a different face or surface from that of the mechanical switch. For example, in some embodiment the scroll bar may be located on a front face or surface of the device with the mechanical switch or switches located on a side surface. The scroll bar may be located along an edge of the front surface or may be located in or near the middle of the front surface. In some embodiments the scroll bar may be limited in functionality to merely providing an up/down scrolling function without additional functions or controls.

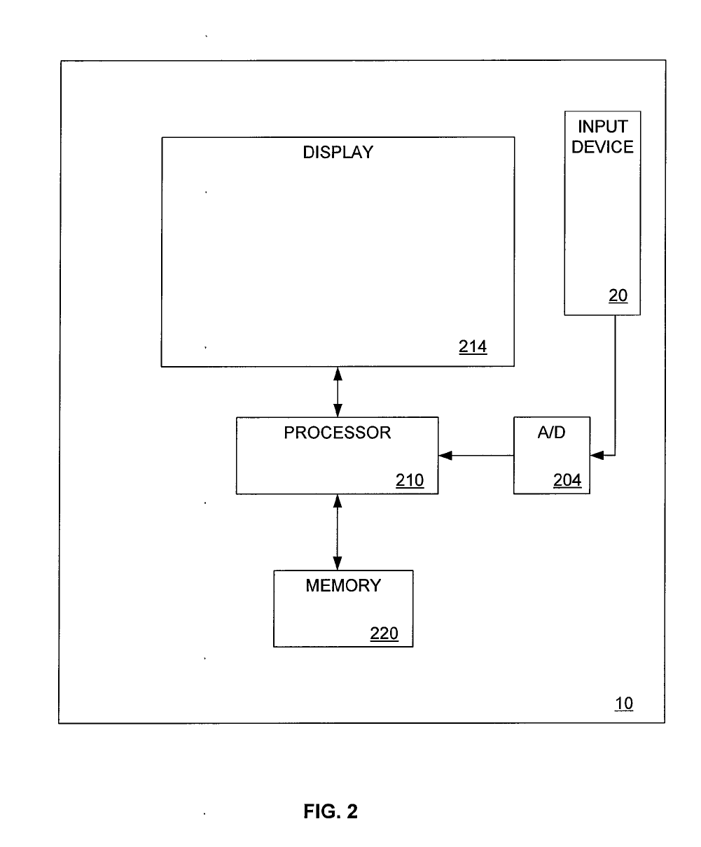

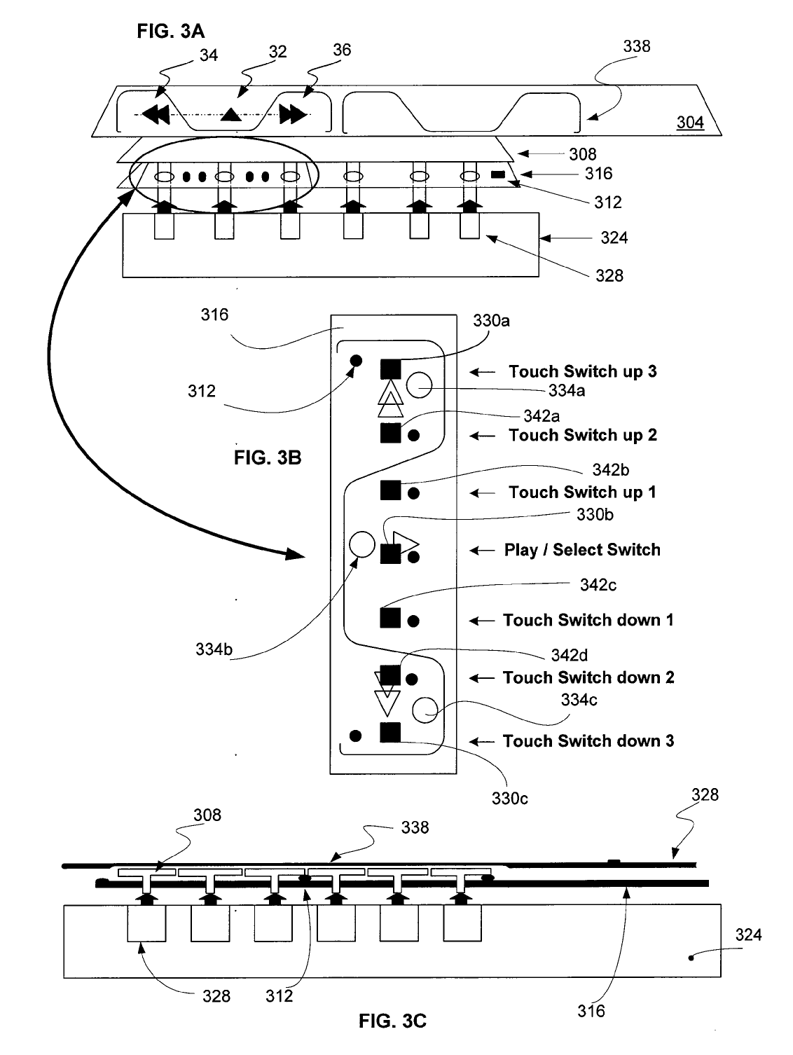

During operation of the audio player 10, a user may utilize the input interface to navigate through lists of audio tracks or folders appearing on a display 214 (FIG. 2). Once the user has scrolled through a displayed list of tracks or folders and removed his or her finger so as to highlight a desired track or folder using the scroll bar 24, the user may push the play/select switch 32 (FIG. 3) in order to control the highlighted track or folder. In this embodiment merely pushing the play/select switch 32 or other control element does not reactive the scroll bar; rather, such reactivation occurs only in response to sliding of the user's finger up or down the bar 24. However, the input interface may be configured such that lightly tapping over the next 34 and back 36 buttons inside the scroll bar 24 causes the displayed list to scroll by one line following each tap.

The audio player 10 will typically be configured to nearly instantaneously enter a hibernation mode following determination that the user's skin is no longer in contact with the input interface 20. This advantageously conserves power by ensuring that the display of the player 10 does not remain illuminated after the player 10 has, for example, been put away in the user's pocket or carrying bag. The player 10 will also generally be configured such that touching any capacitive touch area of the input interface 20 causes the player 10 to immediately transition out of hibernation mode and initiates turn-on of the backlight for the display (not shown) of the audio player 10. This advantageously allows the player 10 to be ready to use more quickly (e.g., after the user removes the player 10 from his or her pocket), and limits user irritation, confusion, and use delays caused by the conventional timing associated with transition in and out of hibernate modes.

Reference is now made to FIG. 2, which is a block diagram depicting a principal set of components of the audio player 10. As shown, the audio player 10 incorporates the input interface 20 of the present invention and an accompanying analog to digital converter (A/D) 204 for converting analog signals generated by the input interface 20 into digital signals intelligible by a processor 210. The audio player 10 further includes a display 214 (e.g., a liquid crystal display or an OLED) and memory 220, both of which are coupled to the processor 210.

Memory 220 stores audio tracks and other information used by processor 210 in connection with operation of the player 10. In addition, memory 220 also stores an operating program for controlling the operation of the player 10, which will generally include a subroutine or sub-program for interpreting and otherwise processing the signals generated by the input interface 20 in the manner described below. This subroutine or sub-program generates appropriate output signals used in controlling the information presented by, for example, a graphical user interface rendered by the display 214. Such output signals may be utilized to control navigation through the graphical user interface, which may involve the controlling of various functions such as scrolling, cursor movement, adjustment of slider controls, and selection of buttons or switches.

Attention is now directed to FIGS. 3A-3C, which provide various views of an exemplary implementation of the input interface 20. In particular, FIGS. 3A and 3C respectively provide partially disassembled and cross-sectional views of the layered structure of the input interface 20. As shown, the top-most layer of the input interface 20 consists of an enclosure material 304. The enclosure layer overlays a light diffusion layer 308 which functions to diffuse the light generated by a plurality of light emitting devices 312, e.g., LED backlights, positioned on a touch-sensitive board 316 underlying the light diffusion layer 308. The touch-sensitive board 316 is interposed between the light diffusion layer 308 and a circuit board 324 incorporating a plurality of push-sensitive mechanical switches 328.

FIG. 3B provides a top view of the arrangement of the elements mounted upon the portion of the touch-sensitive board 316 corresponding to the scroll bar 24. As shown, a touch-sensitive switch 330 is positioned on the scroll bar 24 in vertical alignment with each of its control elements (i.e., play/select switch 32, next button 34, and back button 36). Moreover, the touch-sensitive board 316 defines an aperture 334 in vertical alignment with a push-sensitive mechanical switch 328 supported by the circuit board 324 for each such control elements of the scroll bar 24. Each mechanical switch 328 may be activated in response to finger pressure applied to the portion of the enclosure layer 304 associated with the control element. In order to facilitate flexing or bending of the enclosure material 304 to a degree sufficient to allow activation of the push-sensitive mechanical switches 328, a narrow slit or “cut through” 338 extending through the entirety of the enclosure layer 304 is defined by the pattern indicated in FIG. 3A. This slit or cut-through 338 also permits light emitted by the LED backlights 312 and diffused through the light diffusion layer 308 to pass through the enclosure layer 304 and thus partially illuminate the input interface 20. A touch-sensitive switch 342 is also placed in vertical alignment with a location associated with each of the other control elements incorporated within the scroll bar (i.e., “Touch Switch Up 1”, “Touch Switch Up 2”, “Touch Switch Down 1”, “Touch Switch Down 2”). As is described below, signals generated by these touch-sensitive and mechanical switches are processed in order to generate appropriate control signals used in navigating through the graphical user interface presented by the display 214.

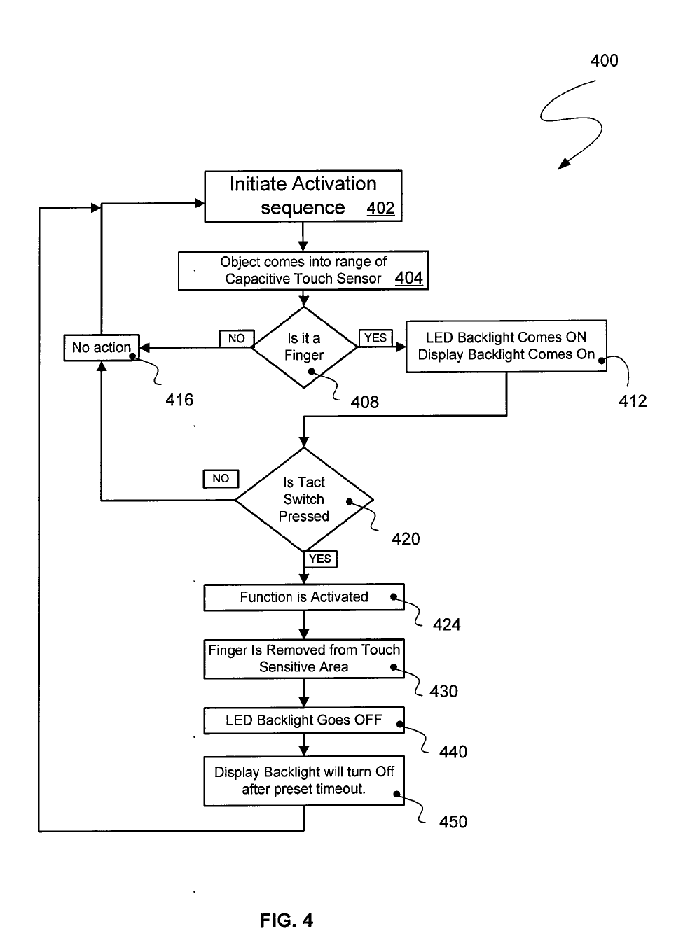

Turning now to FIG. 4, a flowchart 400 is provided of an exemplary sequence of actions occurring in connection with activating one of the control elements (e.g., play/select switch 32) of the inventive input interface 20. In the exemplary embodiment the activation sequence is initiated (stage 402) and controlled by a sub-program or subroutine of the mainline control program stored in memory 220 and executed by the processor 210. In an initial stage 404 of the sequence an object comes into range of the applicable touch-sensitive switch 330, and it is determined (stage 408) based upon the signal provided by the touch-sensitive switch 330 for the control element whether an object contacting the switch is a finger (i.e., whether skin contact has been made). If so, at least the LED backlight 312 mounted upon the touch-sensitive board that is proximate the applicable control element is turned on (stage 412). In other embodiments the LED backlights 312 associated with all the control elements of the input interface 20 and the backlight of the display 214 are also turned on. If skin contact is not made with the touch-sensitive switch for the applicable control element, then no further action is taken (stage 416).

Following the LED backlight turn-on operation, it is determined whether the push-sensitive mechanical switch 328 for the control element has been pressed (stage 420). If not, no further action is taken; if so, the display navigation or other function associated with the control element is activated (stage 424). Once the user's finger is removed from the vicinity of the touch-sensitive switch 330 for the control element (stage 430), the one or more LED backlights 312 which had previously been turned on are turned off (stage 440); otherwise, such backlights are turned off immediately or following expiration of a preset timeout period (state 450).

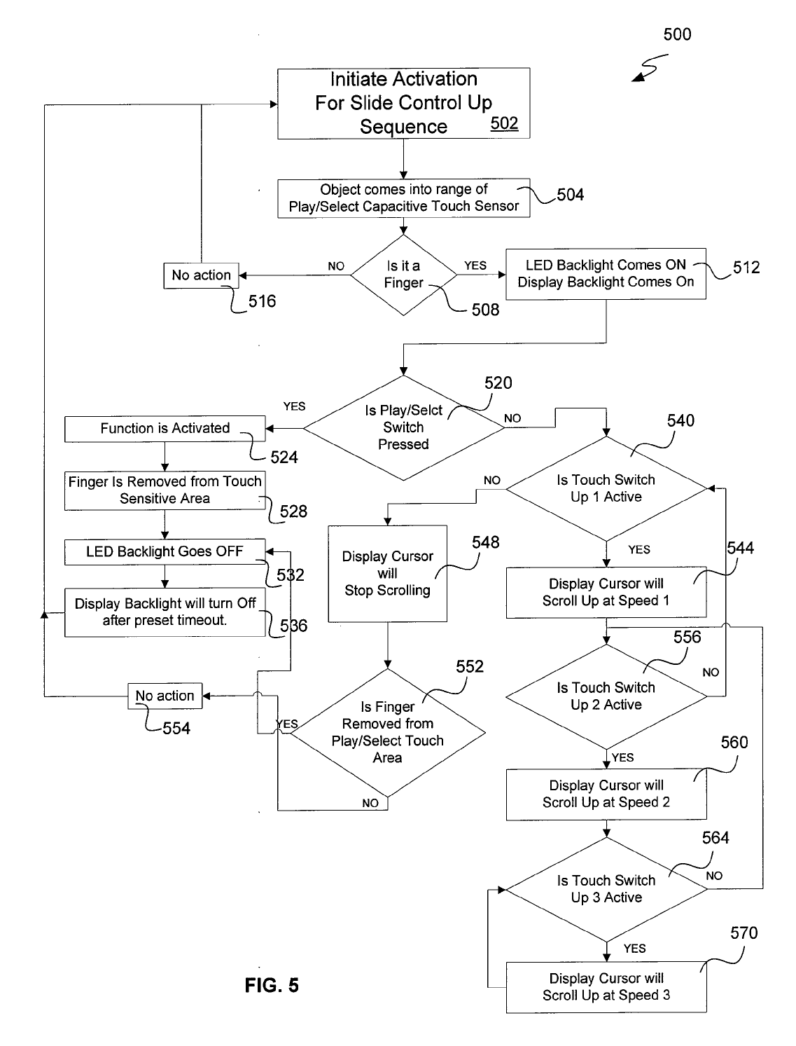

Reference is now made to FIG. 5, which is a flowchart 500 depicting an exemplary sequence of actions occurring in connection with activation of a scroll up control function facilitated by the scroll bar 24 of the inventive input interface 20. Again, a sub-program or subroutine of the mainline control program stored in memory 220 that is initiated (stage 502) and executed by the processor 210 is configured to cause the player 10 to perform operations consistent with the activation sequence of FIG. 5. In an initial stage 504 of the sequence an object comes into range of the applicable touch-sensitive switch 330, and it is determined based upon the signal provided by the touch-sensitive switch 330 for the control element whether an object contacting the switch is a finger (i.e., whether skin contact has been made) (stage 508). If so, at least the LED backlight 312 mounted upon the touch-sensitive board that is proximate the applicable control element is turned on (stage 512). In other embodiments the LED backlights associated with all the control elements of the input interface 20 and the backlight of the display 214 are also turned on. If skin contact is not made with the touch-sensitive switch for the applicable control element, then no further action is taken (stage 516).

Following the LED backlight turn-on operation, it is determined whether the push-sensitive mechanical switch 328 for the play/select switch 32 has been pressed (stage 520). If so, the play/select function is activated with respect to the content or information (e.g., an audio track or folder) highlighted within the graphical user interface currently presented by the display 214 (stage 524). Once the user's finger is removed from the vicinity of the touch-sensitive switch 330 for the play/select switch 32, the one or more LED backlights 312 which had previously been turned on are turned off; otherwise, such backlights are turned off immediately or following expiration of a preset timeout period (stage 536).

As shown in FIG. 5, if the play/select switch 32 has not been pressed, then it is determined whether the Touch Switch Up 1 has been actuated in response to contact with the finger of the user music player 10 (stage 540). If so, and if the Touch Switch Up 2 and Touch Switch Up 3 have each also not been activated, then the cursor of the graphical user interface rendered by the display 214 will scroll in an upward direction at a relative speed of “1” (stage 544). If the Touch Switch Up 1 is determined to not have been actuated, then the display cursor ceases scrolling in the upward direction (stage 548) and any previously turned on LED backlights are extinguished if it is determined that the user's finger has been removed from the vicinity of the play/select switch 32 (stage 552). If the user's finger has not been removed from the vicinity of the play/select switch 32, the no action is taken (stage 554). If both the Touch Switch Up 1 and the Touch Switch Up 2 have both been activated (stage 556) but the Touch Switch Up 3 has not been activated, then the display cursor will scroll in an upward direction at a relative speed of “2” (stage 560). Finally, if all of Touch Switch Up 1, Touch Switch Up 2, and Touch Switch Up 3 have been activated (stage 564), then the display cursor will scroll in an upward direction at a relative speed of “3” (stage 570).

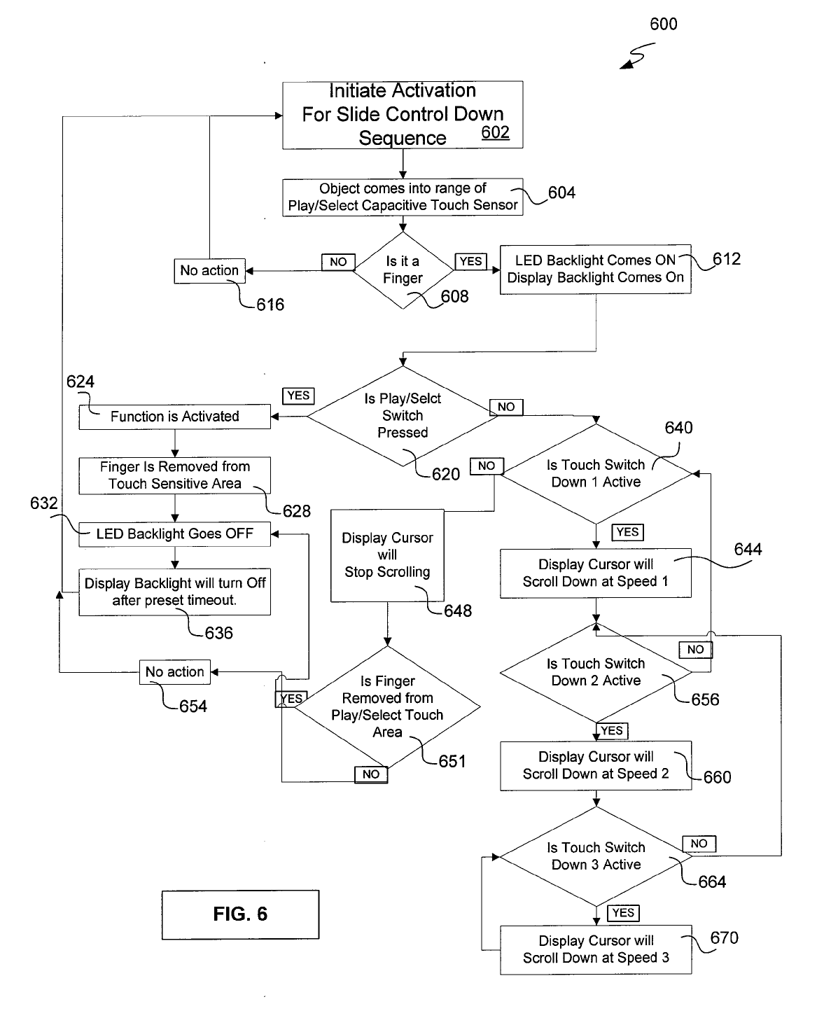

FIG. 6 is a flowchart 600 depicting an exemplary sequence of actions occurring in connection with activation of a scroll down control function facilitated by the scroll bar 24 of the inventive input interface 20. In the exemplary embodiment the activation sequences of FIGS. 5 and 6 are executed in parallel so that the audio player 10 is responsive to either “scroll up” or “scroll down” user input entered through input interface 20. As will be apparent upon comparison of FIGS. 5 and 6, the sequence of actions occurring with respect to activation of the scroll up and scroll down functions are substantially identical and differ only in that the former is responsive to signals generated by the “Touch Switch Up” elements while the latter is responsive to signals generated by the “Touch Switch Down” elements. It is a feature of the present invention that the scroll control algorithms described with reference to FIGS. 5 and 6 enable highly sensitive acceleration and deceleration in the rate of scrolling through lists of information rendered by the graphical user interface of the display 214.

Referring to FIG. 6, a sub-program or subroutine of the mainline control program stored in memory 220 that is initiated (stage 602) and executed by the processor 210 is configured to cause the player 10 to perform operations consistent with the activation sequence of FIG. 6. In an initial stage 604 of the sequence an object comes into range of the applicable touch-sensitive switch 330, and it is determined based upon the signal provided by the touch-sensitive switch 330 for the control element whether an object contacting the switch is a finger (i.e., whether skin contact has been made) (stage 608). If so, at least the LED backlight 312 mounted upon the touch-sensitive board that is proximate the applicable control element is turned on (stage 612). In other embodiments the LED backlights associated with all the control elements of the input interface 20 and the backlight of the display 214 are also turned on. If skin contact is not made with the touch-sensitive switch for the applicable control element, then no further action is taken (stage 616).

Following the LED backlight turn-on operation, it is determined whether the push-sensitive mechanical switch 328 for the play/select switch 32 has been pressed (stage 620). If so, the play/select function is activated with respect to the content or information (e.g., an audio track or folder) highlighted within the graphical user interface currently presented by the display 214 (stage 624). Once the user's finger is removed from the vicinity of the touch-sensitive switch 330 for the play/select switch 32, the one or more LED backlights 312 which had previously been turned on are turned off; otherwise, such backlights are turned off immediately or following expiration of a preset timeout period (stage 636).

As shown in FIG. 6, if the play/select switch 32 has not been pressed, then it is determined whether the Touch Switch Down 1 has been actuated in response to contact with the finger of the user music player 10 (stage 640). If so, and if the Touch Switch Down 2 and Touch Switch Down 3 have each also not been activated, then the cursor of the graphical user interface rendered by the display 214 will scroll in a downward direction at a relative speed of “1” (stage 644). If the Touch Switch Down 1 is determined to not have been actuated, then the display cursor ceases scrolling in the downward direction (stage 648) and any previously turned on LED backlights are extinguished if it is determined that the user's finger has been removed from the vicinity of the play/select switch 32 (stage 652). If the user's finger has not been removed from the vicinity of the play/select switch 32, the no action is taken (stage 654). If both the Touch Switch Down 1 and the Touch Switch Down 2 have both been activated (stage 656) but the Touch Switch Down 3 has not been activated, then the display cursor will scroll in a downward direction at a relative speed of “2” (stage 660). Finally, if all of Touch Switch Down 1, Touch Switch Down 2, and Touch Switch Down 3 have been activated (stage 664), then the display cursor will scroll in a downward direction at a relative speed of “3” (stage 670).

Turning now to FIG. 7, there is shown an audio player 700 configured with an input interface having a touch-sensitive scroll bar 720 realized along a front surface of the device independently from a set of combination push-sensitive/touch-sensitive control buttons located on an adjacent side surface 710 of the player 700. In FIG. 7, the touch-sensitive scroll bar 720 comprises a touch-sensitive strip extending vertically along the entire length of the front surface of the player 700 adjacent its side surface 710. It is believed that this configuration may allow for more controlled scrolling movement.

The scroll bar 720 is actuated in response to sliding of the user's finger over “scroll up” or “scroll down” control portions of the scroll bar. Detection electronics associated with the “scroll up” and “scroll down” control portions generate output signals which are provided to a processor of the player 700, which in turn causes a list of information appearing upon the display 740 of the player 700 to be scrolled up or down, respectively. Once the scroll bar 720 is activated, the user may drag their finger farther up the scroll bar 720 to accelerate up the list, or farther down the scroll bar to accelerate down the list. The user can hold down in one spot to maintain constant acceleration through the list. The scroll bar 720 may be designed such that it operates with respect to a fixed zero point located at the midpoint along its length. Alternatively, the scroll bar 720 may be configured such that the user defines the zero point by the spot from which they begin moving their finger. For example, if the finger motion begins in a downward direction from a top end of the scroll bar, dragging of the user's finger farther down the scroll bar will cause increasingly rapid downward scrolling of the displayed list. Once the user lifts his or her finger off of the scroll bar, the displayed list ceases scrolling. In certain embodiments the touch-sensitive scroll bar 720 may also be used for selection (e.g., by lightly tapping it one or more times in quick succession).

In the embodiment of FIG. 7 the combination push-sensitive/touch-sensitive control buttons located on side surface 710 would typically be used for “clicking” or other selection functions, and would generally not be used for scrolling. A set of iconic representations 730 of the functions performed by each such combination button is provided on the front surface of the player 700. Each iconic representation within the set of representations 730 is in horizontal alignment with the location of a corresponding one of the combination buttons on the side surface 710.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. An electronic device, comprising:
a housing having at least one outside edge;
an input interface disposed along at least a portion of the one outside edge, the input interface including at least one touch-sensitive switch and at least one push-sensitive switch; and
a processor for receiving and processing first input signals generated by the at least one touch-sensitive switch and second input signals generated by the at least one push-sensitive switch, the first and second input signals being generated in response to user input.

2. The electronic device of claim 1 wherein the processor is configured to interpret the successive generation of one of the first input signals and one of the second input signals as a control operation relative to information displayed by a display of the electronic device.

3. The electronic device of claim 1 wherein the processor, in response to the generation of one of the first input signals, sends a turn-on instruction to a light-emitting element of the input interface.

4. The electronic device of claim 1 wherein the processor, in response to the generation of one of the first input signals, sends a turn-on instruction to a backlight element of a display of the electronic device.

5. The electronic device of claim 3 wherein the light-emitting element is located proximate a portion of the input interface associated with a display control function applicable to a display of the electronic device.

6. The electronic device of claim 5 wherein the processor initiates implementation of the display control function when one of the second input signals is generated within a predefined period subsequent to the one of the first input signals.

7. The electronic device of claim 1 wherein the at least one touch-sensitive switch is located in a first horizontal layer of the input interface and the at least one push-sensitive switch is located in a second horizontal layer of the input interface displaced from the first horizontal layer along a vertical axis.

8. The electronic device of claim 1 wherein the at least one touch-sensitive switch and the at least one push-sensitive switch are proximately located relative to a longitudinal axis of the input interface and comprise a first switch pair, the input interface including a second touch-sensitive switch and a second push-sensitive switch comprising a second switch pair.

9. The electronic device of claim 8 wherein the input interface further includes a plurality of touch-sensitive switches positioned substantially along the longitudinal axis between the first switch pair and the second switch pair.

10. The electronic device of claim 1 wherein the at least one touch-sensitive switch comprises a capacitive touch switch.

11. An input interface for an electronic device, the input interface comprising:
a first touch-sensitive switch supported by a board member;
a circuit board; and
a first push-sensitive switch supported by the circuit board.

12. The input interface of claim 11 further including a light emitting element at least partially supported by the board member.

13. The input interface of claim 12 further including an enclosure layer and a light diffusing element, the light diffusing element being interposed between the board member and the enclosure layer.

14. The input interface of claim 11 wherein the first touch-sensitive switch and first push-sensitive switch are located proximate a portion of the input interface associated with a first control function.

15. The input interface of claim 14 further including:
a second touch-sensitive switch supported by the board member; and
a second push-sensitive switch supported by the circuit board.

16. The input interface of claim 15 wherein the second touch-sensitive switch and the second push-sensitive switch are located proximate a portion of the input interface associated with a second control function.

17. The input interface of claim 11 further including a light emitting element located proximate the first touch-sensitive switch on the board member.

18. A method of controlling a display interface of an electronic device using an input interface of the device, the method comprising:
generating, upon touching by a user of a surface of the input interface, a first input signal;
generating, upon application by the user of a pushing force to the surface of the input interface, a second input signal; and
providing a first control signal to the display interface in response to the first input signal and the second input signal.

19. The method of claim 18 wherein the touching and the pushing force are applied proximate a first location of the input interface.

20. The method of claim 19 further including:
generating, upon touching by a user of a second location on the surface of the input interface, a third input signal;
generating, upon application by the user of a pushing force proximate the second location of the surface of the input interface, a fourth input signal; and
providing a second control signal to the display interface in response to the third input signal and the fourth input signal.

21. The method of claim 18 further including illuminating a portion of the input interface in response to the first input signal.

22. The method of claim 18 wherein the providing includes generating the first control signal only if the second input signal is generated within a predetermined time period subsequent to the generating of the first input signal.

23. An electronic device, comprising:
a housing having a display frame portion and at least one outside edge;
an input interface including:
a touch-sensitive scroll bar disposed along at least a portion of the display frame portion, and
at least one touch-sensitive switch and at least one push-sensitive switch proximate a first location on the at least one outside edge; and
a processor for receiving and processing input signals generated by the touch-sensitive scroll bar, at least one touch-sensitive switch, and at least one push-sensitive switch in response to user input.

24. The electronic device of claim 23 wherein the processor is configured to interpret the successive generation of one of input signals from the at least one touch-sensitive switch and the at least one push-sensitive switch as a control operation relative to information displayed by a display of the electronic device bordered by the display frame portion.
